(19) United States
(12) Patent Application Publication
(10) Pub. No.: US 2026/0025867 A1
(43) Pub. Date: Jan. 22, 2026

(54) ENHANCED EHT STA OPERATIONS FOR SPATIAL REUSE, RTWT, AND EMLMR

(71) Applicant: INTERDIGITAL PATENT HOLDINGS, INC., Wilmington, DE (US)

(72) Inventors: Zinan Lin, Basking Ridge, NJ (US); Rui Yang, Greenlawn, NY (US); Hanqing Lou, Syosset, NY (US); Mahmoud Saad, Montreal (CA)

(73) Assignee: INTERDIGITAL PATENT HOLDINGS, INC., Wilmington, DE (US)

(21) Appl. No.: 18/865,842

(22) PCT Filed: Jul. 7, 2023
(86) PCT No.: PCT/US2023/027118

§ 371 Date: Nov. 14, 2024

Related U.S. Application Data
(60) Provisional application No. 63/359,071, filed on Jul. 7, 2022.
(60) Provisional application No. 63/397,173, filed on Aug. 11, 2022.

(51) Int. Cl. H04W 76/15

(52) U.S. Cl. CPC H04W 76/15

(57) ABSTRACT

Methods and apparatuses are described herein how Enhanced Multi-Link Multi-Radio (EMLMR) mode is enabled or disabled in a set of EMLMR links. In one example a beacon frame is received by a station (STA) from an access point (AP) that includes an extremely high throughput (EHT) Operation element including a Disabled Channel Bitmap Present subfield and an EHT Operation Information Present subfield. When the Disabled Channel Bitmap Present subfield is equal to 1, the EHT Operation Information Present subfield is also equal to 1, the STA receives a Disabled Channel Bitmap field indicated in an EHT Operation Information field to determine the allowed subchannels for enhanced multi-link multi-ratio (EMLMR) link(s). EMLMR mode may be enabled/disabled by way of an EML Operating Mode Notification frames and bit values in an EMLMR Bitmap subfield. Additional embodiments are disclosed.

### CROSS-REFERENCE TO RELATED APPLICATIONS

This application claims the benefit of U.S. Provisional Application No. 63/359,071 filed Jul. 7, 2022, and U.S. Provisional Application No. 63/397,183 filed Aug. 11, 2022, the contents of which are incorporated herein by reference.

### BACKGROUND

A trigger frame was introduced in the Institute of Electrical and Electronics Engineers (IEEE) 802.11ax, for example, to allocate resources and trigger single or multi-user access. However, the current design of the trigger frame is not efficient to support new features in the IEEE 802.11be or other standards such as greater bandwidth (BW), multiple resource unit (RU) allocation, enhanced Modulation Coding Scheme (MCS) and greater number of spatial streams. For example, the existing trigger frame includes unnecessary bit resources to provide the spatial reuse features, for example, in the IEEE 802.11be. It is unclear in the current be standards how an Enhanced Multi-Link Multi-Radio (EMLMR) mode may be enabled or disabled in a set of EMLMR links. There is a need to define how to enable or disable the specified set of EMLMR links. In addition, it is not defined how to set an extremely high throughput (EHT) Operation Information Present subfield value if a Disabled Subchannel Bitmap subfield is presented (e.g., disabled subchannels are updated) on the operational link(s). Thus, improved frame designs and/or procedures are needed.

### SUMMARY

In accordance with some aspects, methods and apparatuses are described that define how Enhanced Multi-Link Multi-Radio (EMLMR) mode is enabled or disabled in a set of EMLMR links. Thus, EMLMR mode enabling/disabling procedure(s) and EHT Element transmission on the enabled links are disclosed.

In other aspects, access point (AP) Behavior with Fully Scheduled restricted target wake time (RTWT) is disclosed.

According to certain aspects, methods and apparatuses are described herein for enhanced Extremely High Throughput (EHT) station (STA) operation for spatial reuse (SR). For example, a STA may receive, from an access point (AP), a trigger frame that includes a common info field with a spatial reuse (SR) subfield. The SR subfield may indicate a plurality of SR values for SR operation by the STA. The plurality of SR values, for example, may comprise a first SR value, a second SR value, a third SR value, and a fourth SR value. The STA may determine, based on the plurality of SR values, a first value of a first SR subfield and a second value of a second SR subfield in a U-SIG field of an Extremely High Throughput (EHT) trigger based (TB) physical protocol data unit (EHT TB PPDU). The STA may transmit, using the first value of the first SR subfield and the second value of the second SR subfield, the EHT TB PPDU for the SR operation.

In other aspects, EHT-SIG symbol padding methods and apparatuses are disclosed to add padding to the EHT-SIG field (at bit level or symbol level). Additional features, aspects and embodiments are further described below.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example trigger frame format in 802.11ax;

FIG. 3A is a diagram illustrating an example High Efficiency (HE) variant common info field in a trigger frame;

FIG. 3B is a diagram illustrating an example Extremely High Throughput (EHT) variant common info field format in a trigger frame;

FIG. 4A is a diagram illustrating an example Special User Info field in a trigger frame;

FIG. 4B is a diagram illustrating an example HE Variant User Info field in a trigger frame;

FIG. 4C is a diagram illustrating an example EHT Variant User Info field for all trigger types except a Null Feedback Report Poll (NFRP) trigger;

FIG. 5 is a diagram illustrating an example Control Information subfield format in a Buffer Status Request (BSR) Control subfield;

FIG. 6 is a diagram illustrating an example User Info field format in an NFRP trigger frame;

FIG. 7 is a diagram illustrating an example Enhanced Multi-Link (EML) Control field format;

FIG. 8 is a diagram illustrating an example Enhanced Multi-link multi-radio (EMLMR) Supported MCS And Number of Spatial Stream (NSS) Set subfield format;

FIG. 9 is a diagram illustrating an example frame exchange sequence between an AP affiliated with an AP Multi-Link Device (MLD) and a STA affiliated with a non-AP MLD that is in the Enhanced Multi-Link Single Radio (EMLSR) mode;

FIG. 10 is a diagram illustrating an example frame exchange sequence between an AP (AP 1) affiliated with an AP MLD and n STAs affiliated with n different non-AP MLDs that are in the EMLSR mode;

FIG. 11 is a diagram illustrating an example UL Spatial Reuse Subfield format;

FIG. 12 is a diagram illustrating example mappings between two sets of Spatial Reuse (SR) subfields;

FIG. 13A is a diagram illustrating an example EHT Operation Element format;

FIG. 13B is a diagram illustrating an example EHT Operation Parameters field format;

FIG. 14A is a diagram illustrating an example SR value mapping from the Common Info field to U-SIG of EHT trigger-based (TB) physical protocol data unit (PPDU);

FIG. 14B is a diagram illustrating another example SR value mapping from the Common Info field to U-SIG of EHT TB PPDU;

FIG. 14C is a diagram illustrating another example SR value mapping from the Common Info field to U-SIG of EHT TB PPDU;

FIG. 14D is a diagram illustrating another example SR value mapping from the Common Info field to U-SIG of EHT TB PPDU;

FIG. 15 is a diagram illustrating an example modified EHT Operation Element;

FIG. 16 is a diagram illustrating an example Enhanced EML Control field format 1;

FIG. 17 is a diagram illustrating an example Enhanced EML Control field format 2;

FIG. 18 is a diagram illustrating an example total EMLMR supported MCS and NSS Set subfield format 1;

FIG. 19 is a diagram illustrating an example total EMLMR supported MCS and NSS Set subfield format 2; and

FIG. 20 is a message diagram showing a method for enabling/disabling EMLMR operation according to various embodiments.

### DETAILED DESCRIPTION

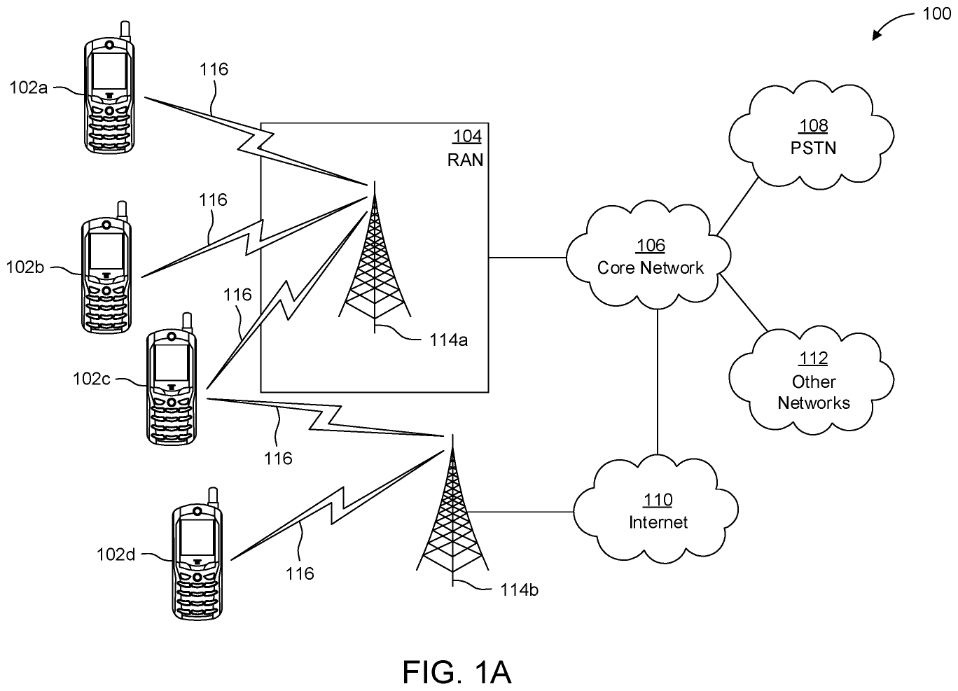

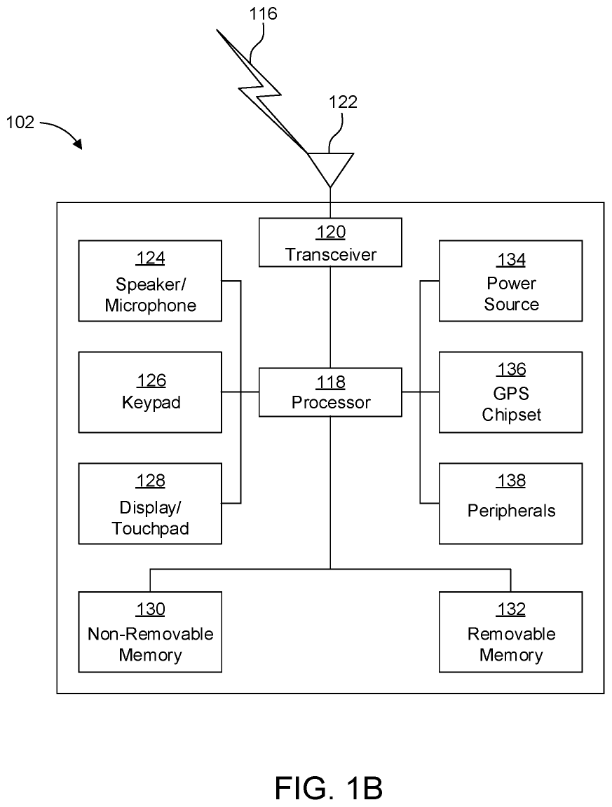

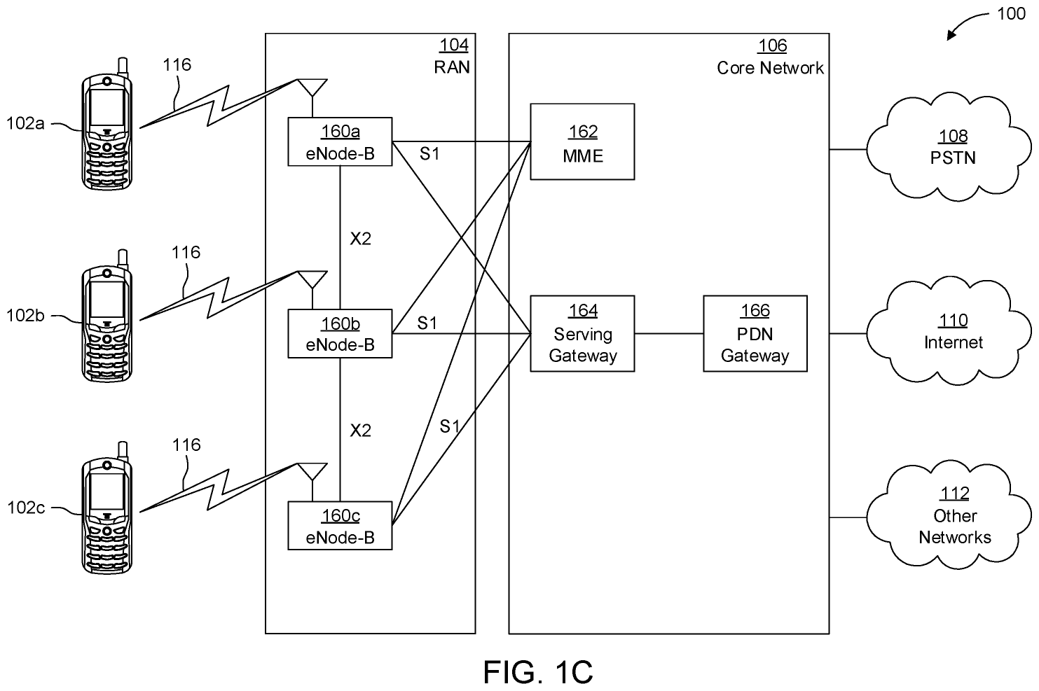

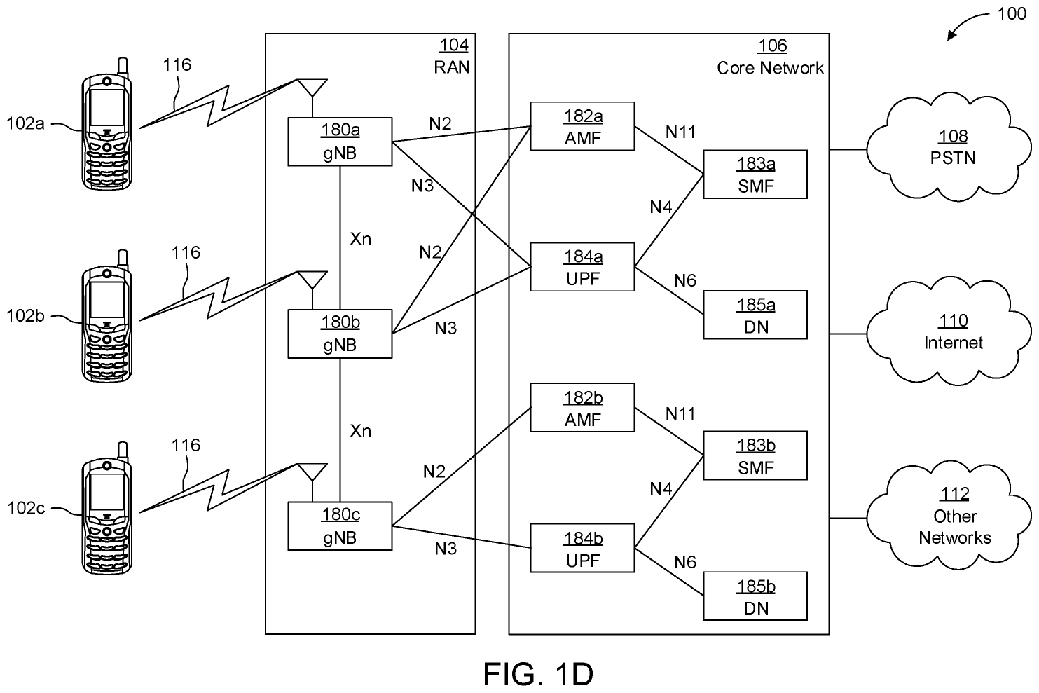

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802. 11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WLAN in Infrastructure Basic Service Set (BSS) mode has an Access Point (AP) for the BSS and one or more stations (STAs) associated with the AP. The AP typically has access or interface to a Distribution

System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT, and time domain, processing are done on each stream separately. The streams are then mapped on to the two channels, and the data is transmitted. At the receiver, this mechanism is reversed, and the combined data is sent to the MAC.

To improve spectral efficiency 802.11ac has introduced the concept for downlink Multi-User MIMO (MU-MIMO) transmission to multiple STA's in the same symbol's time frame, for example, during a downlink OFDM symbol. The potential for the use of downlink MU-MIMO is also currently considered for 802.11ah. It is important to note that since downlink MU-MIMO, as it is used in 802.11ac, uses the same symbol timing to multiple STA's interference of the waveform transmissions to multiple STA's is not an issue. However, all STA's involved in MU-MIMO transmission with the AP need to use the same channel or band, this may limit the operating bandwidth to the smallest channel bandwidth that is supported by the STA's which are included in the MU-MIMO transmission with the AP.

OFDMA was introduced in 802.11ax, High Efficiency (HE) Wi-Fi, to further improve the spectral efficiently and multiple user support in a dense deployment system. To synchronize the uplink transmission, a trigger frame and trigger-based transmissions may be utilized. Target Wake Time (TWT) was revisited and enhanced to improve wake and sleep efficiency on power or battery limited devices.

The IEEE 802.11 Extremely High Throughput (EHT) is formed to further increase peak throughput and improve efficiency of the IEEE 802.11 networks. The primary use cases and applications addressed may include high throughput and low latency applications such as: Video-over-WLAN; Augmented Reality (AR); and Virtual Reality (VR). New features introduced in 802.11be may include: Multi-link operation; 320 MHz bandwidth; 16 spatial stream and MIMO enhancement; Enhanced resource allocation in OFDMA; more flexible preamble puncture scheme.

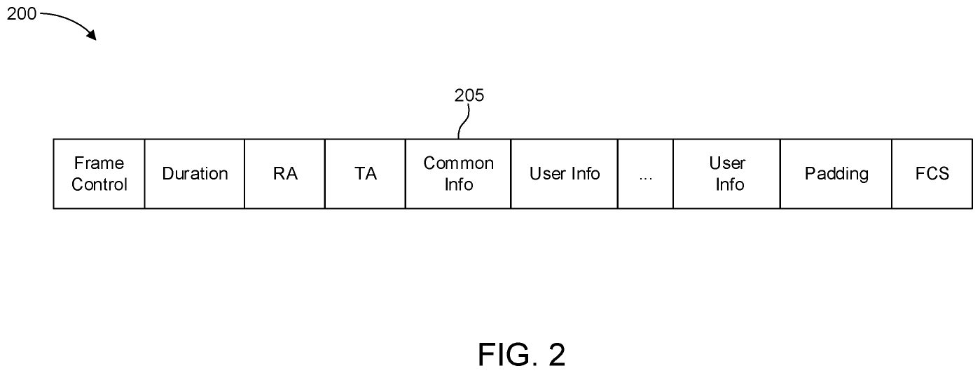

FIG. 2 is a diagram illustrating an example trigger frame format 200 in 802.11ax. The Trigger frame was introduced in 802.11ax. EHT may support greater bandwidth (BW), multiple resource unit (RU) allocation, enhanced modulation and coding scheme (MCS) and greater number of spatial streams. 802.11be modified the trigger frame so that it can support new 802.11be features, and meanwhile is backward compatible with 802.11ax. A trigger frame may be used to allocate resources and trigger single or multi-user access. 802.11be may reuse the same format 200 for the trigger frame with new, additional values/fields/subfields.

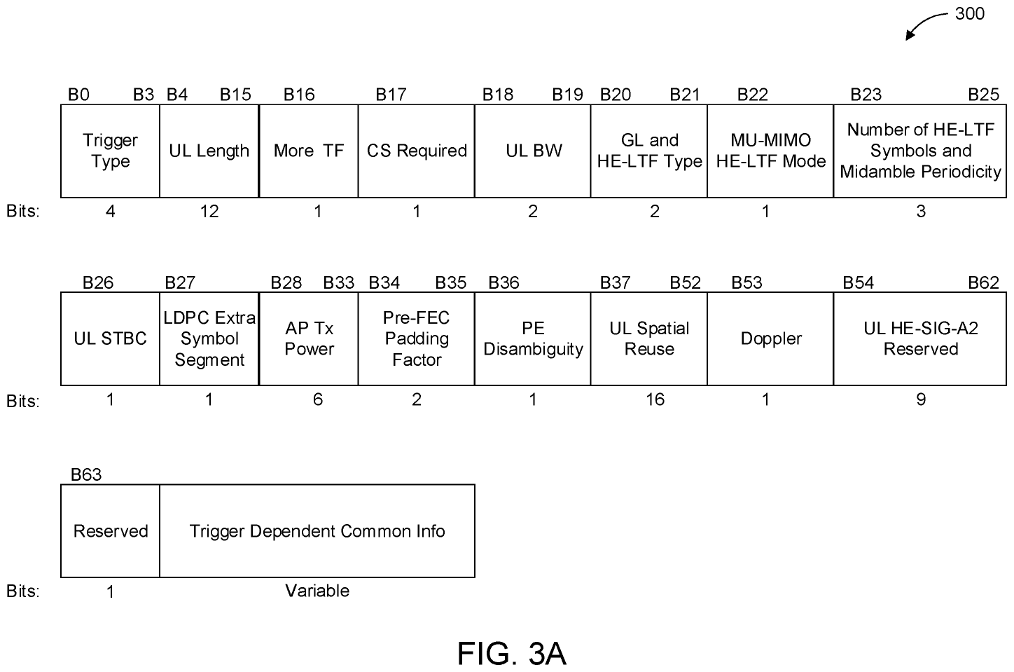

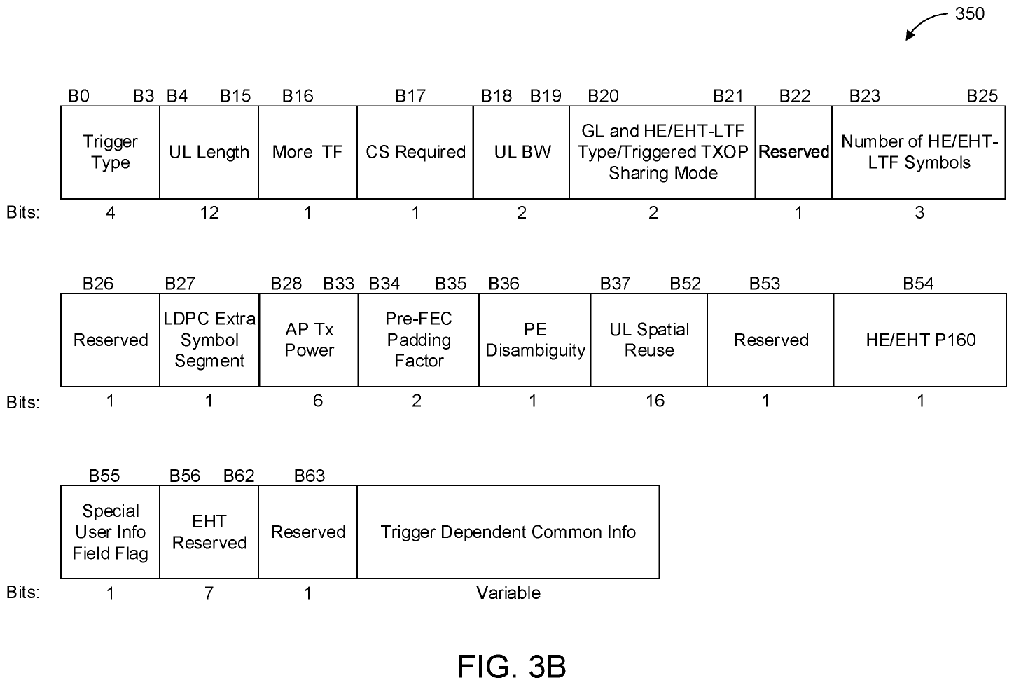

The Common Info field 205 in 802.11be may have two variants, high efficiency (HE) variant and EHT variant. FIG. 3A is a diagram illustrating an example High Efficiency (HE) Variant Common Info field 300 in a trigger frame. FIG. 3B is a diagram illustrating an example Extremely High Throughput (EHT) Variant Common Info field format 350 in a trigger frame.

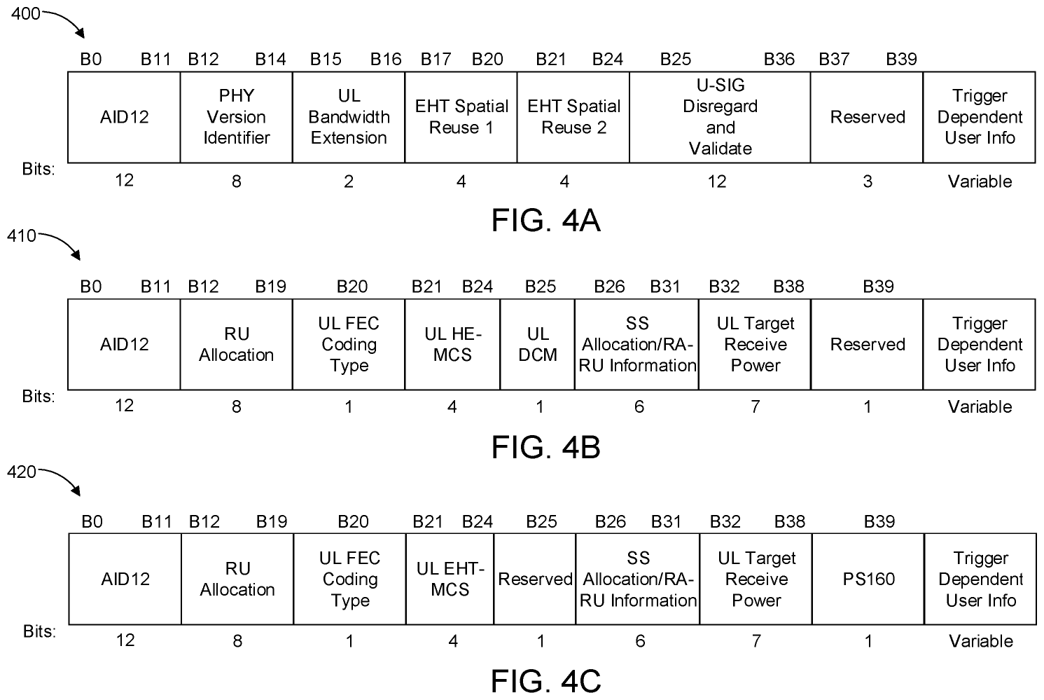

The 802.11be frame may include three types of User Info fields, Special User Info field, HE variant User Info field and EHT variant User Info field. FIG. 4A is a diagram illustrating an example Special User Info field 400 in a trigger frame. As illustrated in FIG. 4A, the Special User Info field 400 may carry extended common information for EHT STAs to transmit a EHT trigger-based (TB) physical layer protocol data unit (PPDU).

FIG. 4B is a diagram illustrating an example HE Variant User Info field 410 in a trigger frame. The HE variant User Info field for all trigger types, except for the Null Feedback Report Poll (NFRP) trigger, may be defined as illustrated in FIG. 4B.

FIG. 4C is a diagram illustrating an example EHT Variant User Info field 420 in a trigger frame. The EHT variant User Info field 420 may be used for all trigger types, except for the Null Feedback Report Poll (NFRP) trigger, and may be defined as illustrated in FIG. 4C.

A Trigger Type subfield in Common Info field(s) above may have values as shown in Table 1.

TABLE 1

| Trigger Type | Trigger frame |
|---|---|
| Subfield value | variant |
| 0 | Basic |
| 1 | BF Report Poll (BFRP) |
| 2 | MU-BAR |
| 3 | MU-RTS |
| 4 | Buffer Status Report |
| | Poll (BSRP) |
| 5 | GCR MU-BAR |
| 6 | Bandwidth Query |
| | Report Poll (BQRP) |
| 7 | NDP Feedback Report |
| | Poll (NFRP) |
| 8-15 | Reserved |

In 11ax, a multi-user request to send (MU-RTS) frame may be used to trigger clear-to-send (CTS) frames from one or more STAs. A RU allocation subfield in User Info field may indicate whether the CTS frame should be transmitted on the primary 20 MHz channel, primary 40 MHz channel, primary 80 MHz channel, 160 MHz channel, or 80+80 MHz channel.

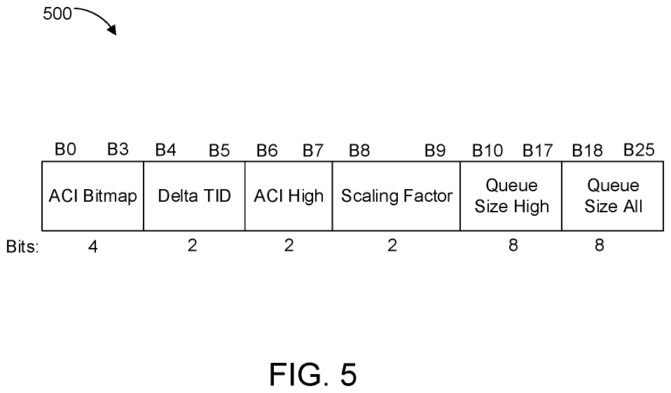

FIG. 5 is a diagram illustrating an example Control Information subfield format 500 in a Buffer Status Request (BSR) Control subfield. In 11ax, an AP may transmit a Buffer Status Report Poll (BSRP) frame to trigger Buffer Status Report (BSR) frame. The BSR frame may be carried in a BSR Control field in MAC header as illustrated in FIG. 5.

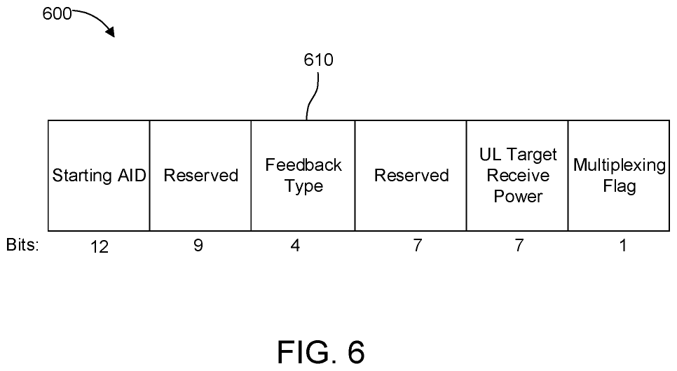

FIG. 6 is a diagram illustrating an example User Info field format 600 in a null feedback report poll (NFRP) trigger frame. The Feedback Type subfield 610 may be set to value=0 may indicate a resource request. The rest of the values may be reserved. The total number of STAs, N_{STA}, that are scheduled to respond to the NFRP trigger frame may be calculated using Equation 1 below:

$${N}_{STA} = 18 \times {2}^{BW} \times ( MultiplexingFlag + 1 ) \qquad ( Equation 1 )$$

A STA with an AID value between the range [Starting AID, Starting AID+N_{STA}−1] may be eligible to respond the NFRP trigger frame.

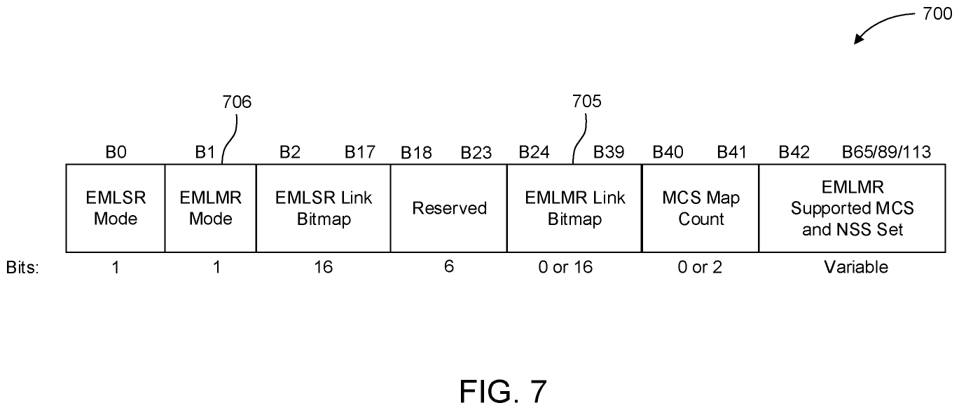

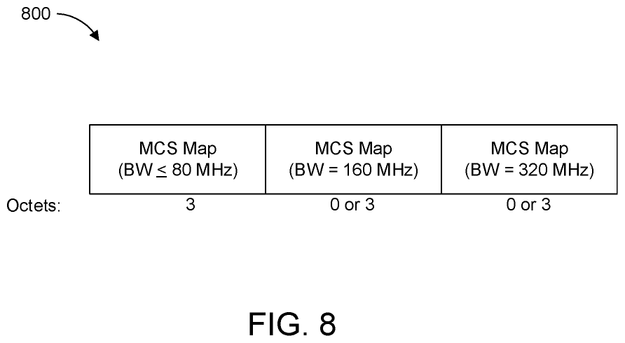

FIG. 7 is a diagram illustrating an example Enhanced Multi-Link (EML) Control field format 700. The Enhanced Multi-Link (EML) Multi-Radio (EMLMR) Link Bitmap subfield 705 may indicate the subset of the enabled links that is used by non-AP Multi-Link Devices (MLDs) in the EMLMR mode. The bit position i of the EMLMR Link Bitmap subfield may correspond to the link with the Link ID equal to i and is set to 1 to indicate that the link is used by the non-AP MLD for the EMLMR mode and is a member of the EMLMR links; otherwise the bit position may be set to 0. The EMLMR Link Bitmap subfield 705 may be present if the EMLMR Mode subfield 706 is equal to 1 and is not present otherwise. FIG. 8 shows a format 800 of the EMLMR Supported MCS And NSS Set subfield. The EMLMR Supported MCS And NSS Set subfield is present if the EMLMR Mode subfield is equal to 1; otherwise it is not present.

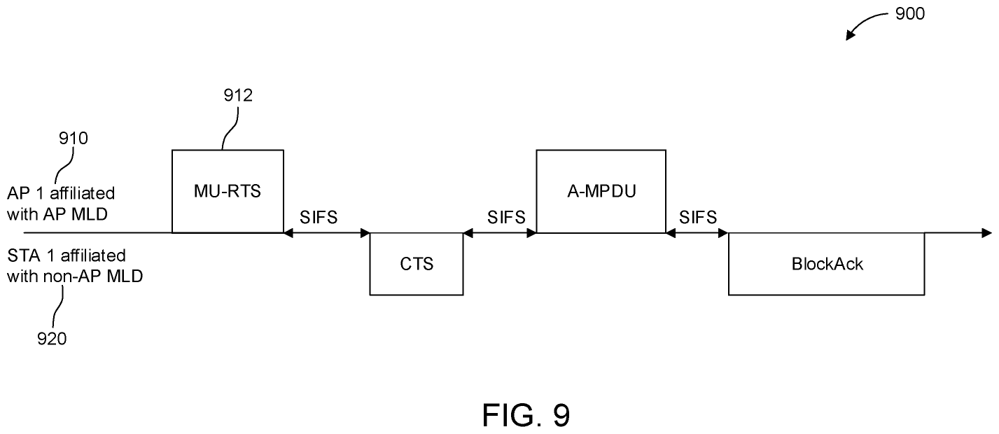

FIG. 9 is a diagram illustrating an example frame exchange sequence 900 between an AP affiliated with an AP Multi-Link Device (MLD) 910 and a STA affiliated with a non-AP MLD 920 that is in the enhanced Multi-Link Single Radio (EMLSR) mode. The EMLMR Supported MCS and number of spatial streams (NSS) Set subfield may be present if the EMLMR Mode subfield (e.g., 706; FIG. 7) is equal to 1; otherwise it is not present.

Enhanced Multi-Link Single Radio (EMLSR) operation may allow a non-AP MLD with multiple receive chains to listen on the EMLSR links when the corresponding STAs affiliated with the non-AP MLD are in awake state as defined below for an initial Control frame sent by an AP affiliated with an AP MLD in a non-HT (duplicate) PPDU with one spatial stream, followed by frame exchanges on the link on which the initial Control frame was received.

A non-AP MLD may operate in the EMLSR mode on a specified set of the enabled links between the non-AP MLD and its associated AP MLD. The specified set of the enabled links in which the EMLSR mode is applied may be referred to as EMLSR links. The EMLSR links may be indicated in the EMLSR Link Bitmap subfield of the EML Control field of the EML Operating Mode Notification frame by setting the bit positions of the EMLSR Link Bitmap subfield to 1. For the EMLSR mode enabled in a single-radio non-AP MLD, the STA(s) affiliated with the non-AP MLD that operates on the link(s) that corresponds to the bit position(s) of the EMLSR Link Bitmap subfield set to 0 may be in doze state if the STA affiliated with the non-AP MLD that operates on one of the EMLSR links is in awake state.

When a non-AP MLD is operating in the EMLSR mode with an AP MLD supporting the EMLSR mode, the following examples may apply.

The non-AP MLD may be able to listen on the EMLSR links, by having its affiliated STA(s) corresponding to those links in awake state. The listening operation may include clear channel assessment (CCA) and receiving the initial Control frame of frame exchanges that is initiated by the AP MLD (e.g., 910; FIG. 9).

An AP affiliated with the AP MLD that initiates frame exchanges with the non-AP MLD on one of the EMLSR links may begin the frame exchanges by transmitting the initial Control frame to the non-AP MLD with the limitations specified as below.

First, the initial Control frame of frame exchanges may be sent in the non-HT PPDU or non-HT duplicate PPDU format using a rate of 6 Mbps, 12 Mbps, or 24 Mbps.

Second, the non-AP MLD may indicate the minimum MAC padding duration of the Padding field of the initial Control frame in the EMLSR Padding Delay subfield of the EML Capabilities subfield in the Common Info field of the Basic Multi-Link element.

Lastly, the initial Control frame may be a MU-RTS trigger frame (e.g., 912; FIG. 9) or a BSRP trigger frame. A STA affiliated with a non-AP MLD that is in the listening operation and that receives MU-RTS trigger frame 912 (or a BSRP trigger frame addressed to it), may respond as defined in rules for soliciting UL MU frames except when the frame exchanges initiated by the initial Control frame on one of the EMLSR links overlaps with group addressed frame transmissions on the other EMLSR link where the non-AP STA intends to receive the group addressed frames. The number of spatial streams for the response to the BSRP trigger frame may be limited to one.

After receiving the initial Control frame of frame exchanges and transmitting an immediate response frame as a response to the initial Control frame, a STA affiliated with the non-AP MLD that was listening on the corresponding link may be able to transmit or receive frames on the link in which the initial Control frame was received and may not transmit or receive on the other EMLSR link(s) until the end of the frame exchanges, and subject to its spatial stream capabilities, operation mode, and link switch delay. The STA affiliated with the non-AP MLD may be capable of receiving a PPDU that is sent using more than one spatial stream on the link in which the initial Control frame was received a SIFS after the end of its response frame transmission solicited by the initial Control frame. During the frame exchanges, the other AP(s) affiliated with the AP MLD may not transmit frames to the other STA(s) affiliated with the non-AP MLD on the other EMLSR link(s).

The non-AP MLD may be switched back to the listening operation on the EMLSR links after the time indicated in an EMLSR Transition Delay subfield of the EML Capabilities subfield in the Common Info field of the Basic Multi-Link element if any of predetermined conditions is met and this is defined as the end of the frame exchanges.

The AP affiliated with the AP MLD may transmit, before the transmission network allocation vector (TXNAV) timer expires, another initial Control frame addressed to the STA affiliated with the non-AP MLD if the AP intends to continue the frame exchanges with the STA and did not receive the response frame from this STA for the most recently transmitted frame that requires an immediate response after a SIFS.

When a STA of the non-AP MLD initiates a TXOP, the following may apply.

First, the non-AP MLD may switch back to the listening operation on the EMLSR links after the time duration indicated in the EMLSR Transition Delay subfield after the end of the TXOP.

Second, only one STA affiliated with the non-AP MLD that is operating on one of the EMLSR links may initiate frame exchanges with the AP MLD.

As mentioned previously, FIG. 9 is a diagram illustrating an example frame exchange sequence 900 between an AP affiliated with an AP multi-link device (MLD) 910 and a STA affiliated with a non-AP MLD 920 that is in the enhanced Multi-Link Single Radio (EMLSR) mode. An example of a frame exchange sequence that starts with the MU-RTS trigger frame 912 between an AP affiliated with an AP MLD 910 and a STA affiliated with a non-AP MLD 920 that is in the EMLSR mode.

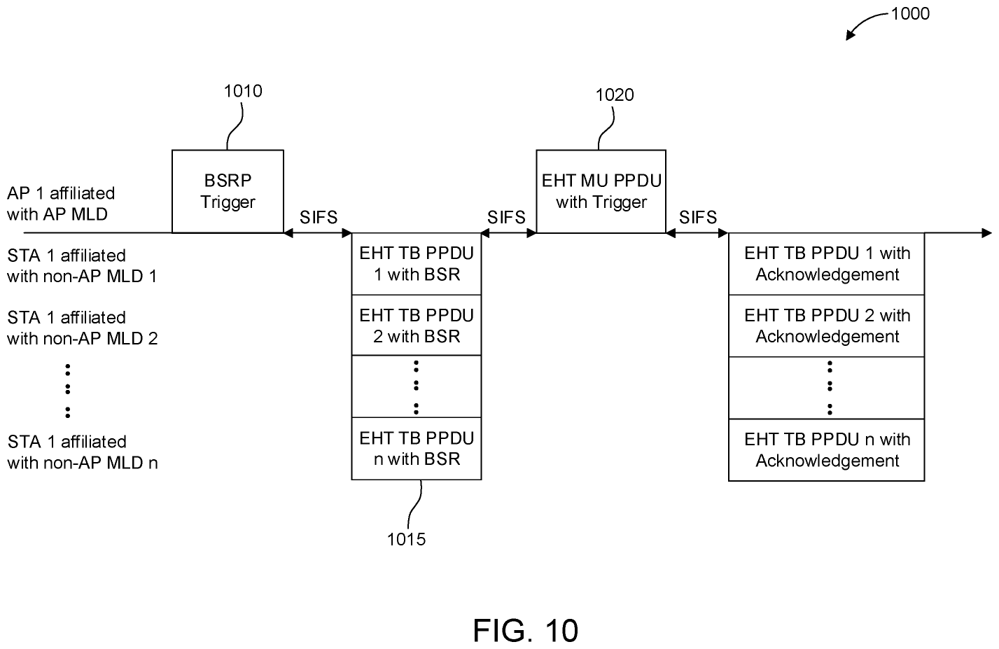

FIG. 10 is a diagram illustrating an example frame exchange sequence 1000 between an AP (AP1) affiliated with an AP MLD and (n) number of STAs (STA1) affiliated with (n) different non-AP MLDs (MLD 1-n) that are in the EMLSR mode. An example of a frame exchange sequence 1000 starts with the BSRP trigger frame 1010 between an AP (AP1) affiliated with an AP MLD and n STAs (STA1) affiliated with n different non-AP MLDs (MLD 1-MLD n) that are in the EMLSR mode.

A non-AP MLD may operate in the EMLMR mode on a specified set of the enabled links between the non-AP MLD and its associated AP MLD. The specified set of the enabled links in which the EMLMR mode is applied may be called “EMLMR links.” A STA of the non-AP MLD that is on an EMLMR link may be an EMLMR STA. The EMLMR links may be indicated in the EMLMR link bitmap subfield of the EML control field of the EML Operating Mode Notification frame by setting the bit positions of the EMLMR Link Bitmap subfield to 1.

When a non-AP MLD with dot11EHTEMLMROptionImplemented equal to true (re)associates with an AP MLD, the EMLMR mode may be disabled by default. If a non-AP MLD with dot11EHTEMLMROptionImplemented equal to true intends to switch EMLMR mode after MLD association, then a non-AP STA affiliated with the non-AP MLD may transmit an EML Operating Mode Notification frame 1015 with EMLMR Mode subfield equal to 1 or 0 to enable or disable the EMLMR mode, respectively.

After successful transmission of the EML Operating Mode Notification frame 1015 from the non-AP STA affiliated with the non-AP MLD to an AP affiliated with an AP MLD, the non-AP STA and the AP may initialize the transition timeout timer with the Transition Timeout subfield value in the EML Capabilities subfield of the Basic Multi-Link element received from the AP. The transition timeout timer begins counting down from the end of the PPDU 1020 containing the immediate response to the EML Operating Mode Notification frame. The AP may send an EML Operating Mode Notification frame 1020 for confirming the mode switch at the AP MLD side to the non-AP STA with EML Control field set to the same value as EML Control field in the received EML Operating Mode Notification frame from the non-AP STA before the transition timeout expires.

The number of resource allocation subfields are described herein. For example, 802.11be EHT-SIG may include RU Allocation-1 and RU Allocation-2 subfields for different bandwidths. Table 2 shows the number(s) of RU-Allocation 1 and RU-Allocation 2 for different bandwidths.

TABLE 2

| | | | Total Number of RU- |
|---|---|---|---|
| | RU-Allocation 1 | RU-Allocation 2 | Allocation Subfields |
| Bandwidth | M | N | M + N |
| 20 | 1 | 0 | 1 |
| 40 | 1 | 0 | 1 |
| 80 | 2 | 0 | 2 |
| 160 | 2 | 2 | 4 |
| 320 | 2 | 6 | 8 |

Table 3 shows the allowed MCSs for EHT-SIG symbols, where R is the coding rate, N_{BPSCS} is the number of bits per subcarrier per spatial stream, N_{SD} is the effective number of data tones carrying unique data, N_{CBPS} is the number of coded bits per OFDM symbol, and N_{DBPS} is the number of data bits per OFDM symbol

TABLE 3

| Value of the | | | | | | | | EHT-SIG |
|---|---|---|---|---|---|---|---|---|
| EHT-SIG | EHT-MCS | | | | | | | rate |
| MCS field | index | Modulation | R | N_{BPSCS} | N_{SD} | N_{CBPS} | N_{DBPS} | (Mb/s) |
| 0 | EHT-MCS 0 | BPSK | ½ | 1 | 52 | 52 | 26 | 6.6 |
| 1 | EHT-MCS 1 | QPSK | ½ | 2 | 52 | 104 | 52 | 13.2 |
| 2 | EHT-MCS 3 | 16-QAM | ½ | 4 | 52 | 208 | 104 | 26.0 |
| 3 | EHT-MCS 15 | BPSK-DCM | ½ | 1 | 26 | 26 | 13 | 3.3 |

Note -
The parameter N_{SD}, N_{CBPS}, and N_{DBPS}, are used for the EHT-SIG field transmission in each 20 MHz subchannel.

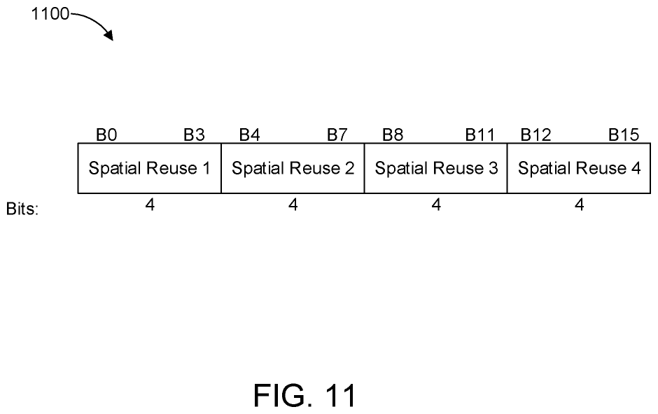

FIG. 11 is a diagram illustrating an example UL Spatial Reuse Subfield format 1100. In the current 802.11be (EHT), the EHT variant Common Info field of the trigger frame (as illustrated in FIG. 3B) may include a 16-bit UL Spatial Reuse (SR) subfields (B37-B52), which is further split into four subfields (e.g., SR1, SR2, SR3 and SR4). Each of the four subfields may have 4 bits.

In addition, if the Special User Info Field Flag subfield (B55) in the EHT variant Common Info field (illustrated in FIG. 3B) is set to 0, the EHT variant Common Info field is may be followed by a Special User Info subfield (illustrated in FIG. 4A) which also includes 8-bit (EHT) Spatial Reuse subfields, which include two 4-bit subfields: EHT Spatial Reuse 1 (ESR1) and EHT Spatial Reuse 2 (ESR2).

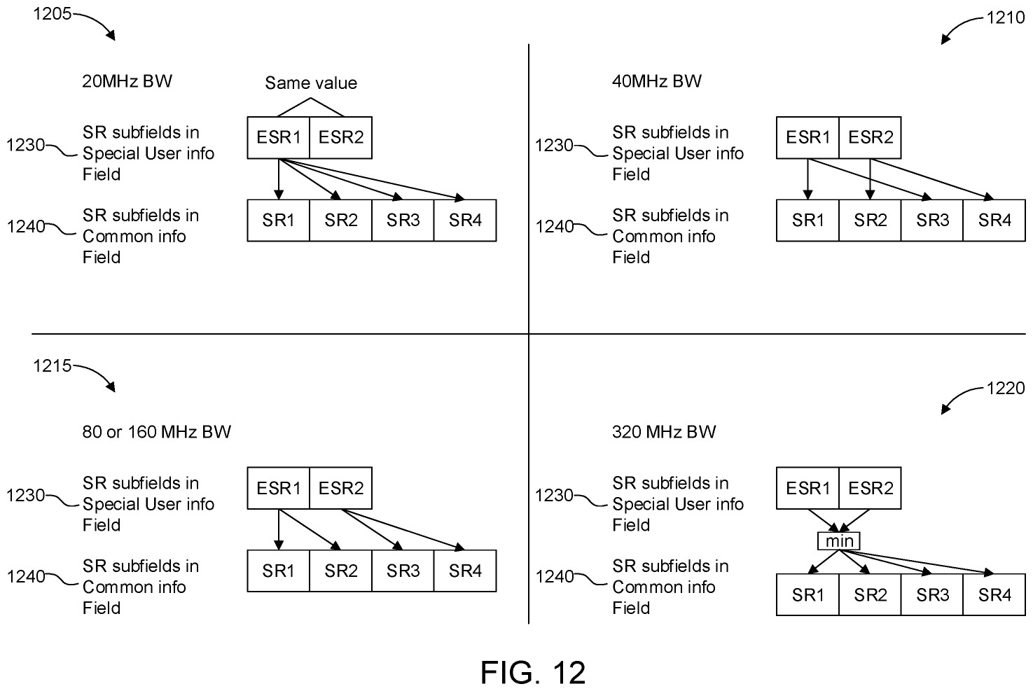

FIG. 12 is a diagram illustrating example mappings 1205, 1210, 1215 and 1220 between two sets of Spatial Reuse (SR) subfields 1230 and 1240. The relationship between the SR subfields 1240 in the Common Info field and ESR subfields 1230 in the Special User Info subfield as the following.

In mapping 1205, when the trigger frame solicits a 20 MHz EHT TB PPDU, each Spatial Reuse n subfield, for n=1,2,3 and 4, of the Common Info field may be set to the value of the EHT Spatial Reuse 1 subfield of the Special User Info field. In this case the values in the EHT Spatial Reuse 1 subfield and the EHT Spatial Reuse 2 subfield of the Special User Info field may be the same.

In mapping 1210, when the trigger frame solicits a 40 MHz EHT TB PPDU, the Spatial Reuse 1 subfield and the Spatial Reuse 3 subfield of the Common Info field may be set to the value of the EHT Spatial Reuse 1 subfield of the Special User Info field and the Spatial Reuse 2 subfield and the Spatial Reuse 4 subfield of the Common Info field may be set to the value of the EHT Spatial Reuse 2 subfield of the Special User Info field.

In mapping 1215, when the trigger frame solicits an 80 MHz EHT TB PPDU or a 160 MHz EHT TB PPDU, the Spatial Reuse 1 subfield and the Spatial Reuse 2 subfield of the Common Info field may be set to the value of the EHT Spatial Reuse 1 subfield of the Special User Info field and the Spatial Reuse 3 subfield and the Spatial Reuse 4 subfield of the Common Info field are set to the value of the EHT Spatial Reuse 2 subfield of the Special User Info field.

For mapping 1220, when the trigger frame solicits a 320 MHz EHT TB PPDU, each Spatial Reuse n subfield, n=1,2,3 and 4, of the Common Info field may be set to the smaller of the values of the EHT Spatial Reuse 1 subfield and the EHT Spatial Reuse 2 subfield of the Special User Info field.

After a solicited non-AP EHT STA receives the trigger frame with the Special User Info field, it will apply the values in the EHT Spatial Reuse 1 subfield and the EHT Spatial Reuse 2 to the corresponding SR fields in the U-SIG in EHT TB PPDU. The trigger frame may have total 24-bits for Spatial Reuse. As there may be unnecessary bit resources for the spatial reuse feature and a more efficient design may be desirable.

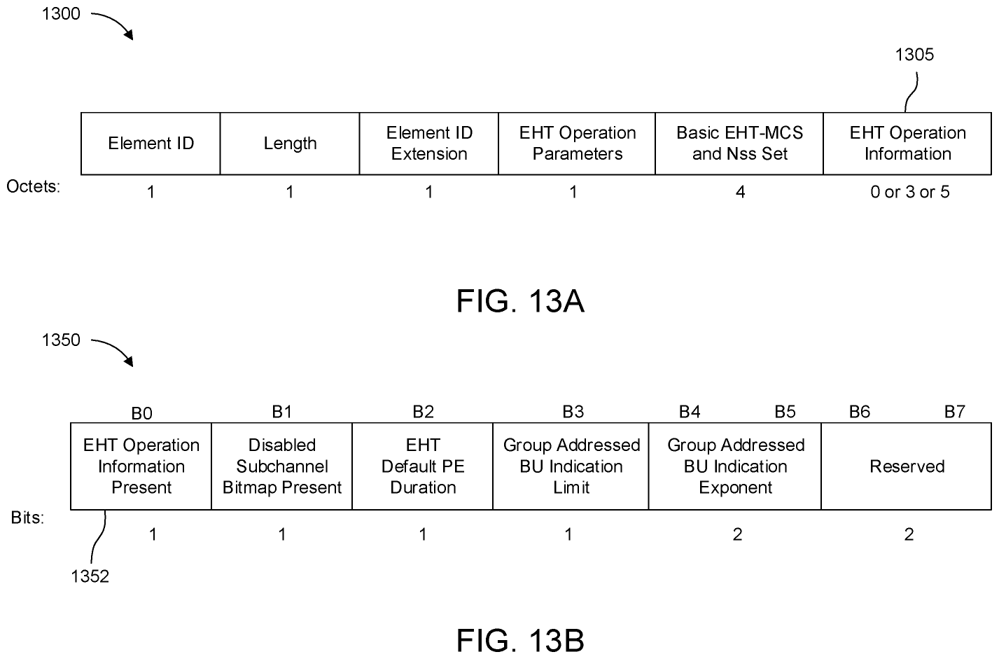

FIG. 13A is a diagram illustrating an example EHT Operation Element format 1300. FIG. 13B is a diagram illustrating an example EHT Operation Parameters field format 1350. The Disabled Subchannel Bitmap Present may be defined in the EHT Operation Information field, which is optionally present in the EHT Operation element 1300. The EHT Operation Information field 1305 may be present if the channel width indicated in an HT Operation, VHT Operation, or HE Operation element that is present in the same Management frame is different from the Channel Width field indicated in the EHT Operation Information field. If the channel width is the same, but the Disabled subchannel Bitmap is updated, the EHT Operation Information Present subfield 1352 may or may not be set=1.

In 11be, a STA may be recommended not to request to establish membership in an r-TWT schedule advertised by the r-TWT scheduling AP with restricted TWT Schedule Full subfield set to 1. But a STA may not follow the recommendation and still request to establish membership in an r-TWT when the Restricted TWT Schedule Full subfield is set to 1. The AP behavior may need to be specified when this scenario happens.

In 802.11be, there may be a per-link limit on the number of spatial streams when a non-AP MLD operates in EMLMR mode. When multiple links are enabled in a non-AP MLD, it may be required to define a limit on the total number of spatial streams across these enabled links. In addition, how EMLMR mode is enabled or disabled in the set of EMLMR links may need to be specified. There is a need to define the procedure to enable or disable the specified set of EMLMR links.

Padding may be used in EHT or any other wireless communication system to adjust a chunk of data to the next whole number of octets or OFDM symbols. Padding may be either performed in a bit level (i.e., bit-level padding) and/or in a symbol level (i.e., symbol-level padding). In EHT, padding can be added to the EHT-SIG field (e.g., in a bit-level and/or in a symbol-level) for different purposes which includes Nonsimultaneous Transmit and Receive (NSTR) PPDU alignment and A-PPDU alignment. Methods and apparatuses that efficiently add padding to EHT-SIG are needed.

Embodiments for Spatial Reuse Subfield in the trigger frame are described herein.

In one embodiment, when the EHT TB PPDU bandwidth is 20, 40, 80 or 160 MHz, the Special User Info field may not allocate any bits for SR. Instead, the SR subfields in the U-SIG of EHT TB PPDU can obtain the values from the SR subfields in the Common Info fields as described below.

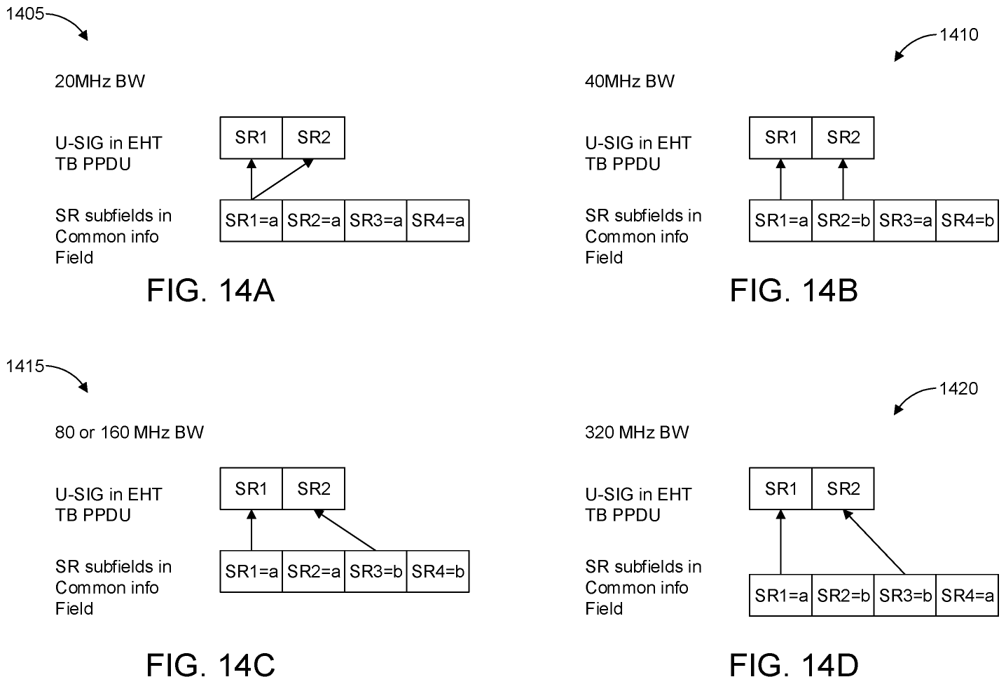

FIG. 14A is a diagram illustrating an example SR value mappings 1405, 1410, 1415 and 1420 from the common info field to the U-SIG field of an EHT trigger-based (TB) physical protocol data unit (PPDU). In mapping 1405, for a 20 MHz EHT TB PPDU, the AP may set four SR subfields, SR1, SR2, SR3, SR4 in the Common Info field of the trigger frame with the same value, and the triggered STA may use the value of any of those subfield to set the SR1 and SR2 subfield in the U-SIG as illustrated in FIG. 4A.

FIG. 14B is a diagram illustrating another example SR value mapping 1410 from the common info field to the U-SIG of an EHT TB PPDU. For a 40 MHz EHT TB PPDU, the AP may set SR subfields SR1 and SR3 in the Common Info field of the trigger frame with the same value (e.g., SR1=SR3=a), and SR2 and SR4 in the Common Info field of the trigger frame with the same value (e.g., SR2=SR4=b). The triggered STA may use the value in SR1 or SR3 subfields of the Common Info field to set the SR1 subfield in the U-SIG and use the value in SR2 or SR4 subfields of the Common Info field to set the SR2 subfield in the U-SIG, as illustrated in FIG. 14B.

FIG. 14C is a diagram illustrating another example SR value mapping 1415 from the Common Info field to the U-SIG of the EHT TB PPDU. For an 80 or 160 MHz EHT TB PPDU, the AP may set SR subfields SR1 and SR2 in the Common Info field of the trigger frame with the same value (e.g., SR1=SR2=a), and SR3 and SR4 in the Common Info field of the trigger frame with the same value (e.g., SR3=SR4=b). The triggered STA may use the value in SR1 or SR2 subfields of the Common Info field to set the SR1 subfield in the U-SIG and use the value in SR3 or SR4 subfields of the Common Info field to set the SR2 subfield in the U-SIG, as illustrated in FIG. 14C. Alternatively or additionally, the AP may set four SR subfields, SR1, SR2, SR3, SR4 in the common info field of the trigger frame with the different values, for example, SR1=a, SR2=b, SR3=c, and SR4=d. Then, the triggered STA may use the minimum value in SR1 and SR2 (or any pair in SR1, SR2, SR3 and SR4) subfields of the Common Info field (i.e., min(a,b) to set the SR1 subfield in the U-SIG and use the minimum value in SR3 and SR4 (or any other pair in SR1, SR2, SR3 and SR4) subfields of the Common Info field (i.e., min(c, d) to set the SR2 subfield in the U-SIG.

FIG. 14D is a diagram illustrating another example SR value mapping 1420 from the common info field to U-SIG of EHT TB PPDU. When the EHT TB PPDU bandwidth is 320 MHz, a STA or an AP may still use 8-bits in the Special User Info field to indicate the SR values. Those bits may be set as “reserved” in other channel bandwidth situations.

Alternatively or additionally, the AP can set SR subfields SR1 and SR4 in the Common Info field of the trigger frame with the same value (e.g., SR1=SR4=a), and SR2 and SR3 in the Common Info field of the trigger frame with the same value (e.g., SR2=SR3=b). The triggered STA will use the value in SR1 or SR4 subfields of the Common Info field to set the SR1 (or SR2) subfield in the U-SIG and use the value in SR2 or SR3 subfields of the Common Info field to set the SR2 (or SR1) subfield in the U-SIG, as illustrated in FIG. 14D. In this embodiment, there is no need to allocate any bit in the Special User Info subfield for SR.

In another embodiment, “a” and “b” in the above method can be set the same, for example, “a”. In this case, the values in SR1 and SR2 subfields in the U-SIG may also be the same.

In another embodiment, the AP may set four SR subfields, SR1, SR2, SR3, SR4 in the Common Info field of the trigger frame with the different values, for example, SR1=a, SR2=b, SR3=c, and SR4=d. Then, the triggered STA may use the minimum value in SR1 and SR2 subfields (or any pair in SR1, SR2, SR3 and SR4) of the Common Info field (i.e., min(a,b)) to set the SR1 subfield in the U-SIG and use the minimum value in SR3 and SR4 subfields (or any other pair in SR1, SR2, SR3 and SR4) of the Common Info field (i.e., min(c, d)) to set the SR2 subfield in the U-SIG.

In one embodiment, a 4-bit SR field may be defined in the Special User Info field. For 20 MHz-160MHz bandwidth cases, the methods in the embodiment described above may be applied, and the SR field in Special User Info field may be reserved. For the 320 MHz case, the SR1, SR2, SR3, SR4 fields in the Common Info field may be set to the same value which may be used to indicate the SR value for the primary (or higher or lower) 160 MHz subchannel. The SR field in the Special User Info field may be set to a value which may indicate the SR value for the secondary 160 MHz (or lower or higher) subchannel.

Embodiments for the presence of the Disabled Subchannel Bitmap are described herein.

In one embodiment, the EHT Operation Information field may be always present if Disabled Subchannel Bitmap is included. The EHT Operation Information Present subfield may be set to 1 if one or more conditions below are met:
(1) The channel width indicated in an HT Operation, VHT Operation, or HE Operation element that is present in the same management frame is different from the Channel Width field indicated in the EHT Operation Information field; and/or
(2) The Disabled Subchannel Bitmap is updated and/or the Disabled Subchannel Bitmap Present subfield in EHT Operation Parameters field is set to 1 and/or the AP may have one or more subchannels punctured for the BSS in the Beacon Interval.

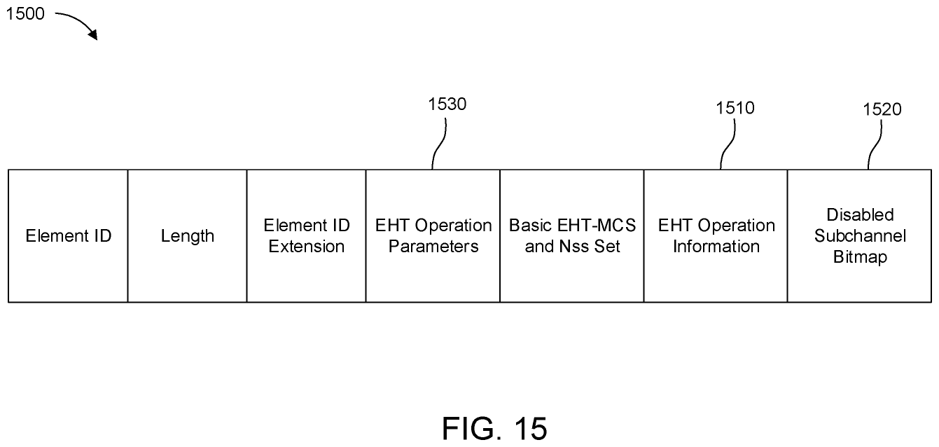

FIG. 15 is a diagram illustrating an example modified EHT operation element 1500. In one embodiment, the EHT Operation element may be redefined (as illustrated in FIG. 15) such that the Disabled Subchannel Bitmap field 1520 is decoupled with the EHT Operation Information field 1510. The Disabled Subchannel Bitmap field 1520 may be optionally present with a size of 0 or 2 octets. The presence of the Disabled Subchannel Bitmap field 1520 may depend on the Disabled Subchannel Bitmap Present subfield located in the EHT Operation Parameters field 1530.

In some scenarios, a non-AP STA may miss the latest Disabled Subchannel Bitmap. For example, the STA may wake up from a Doze mode/Power Save mode and miss the Beacon frame. Alternatively, or additionally, the STA may switch from another link to the current link and miss the Beacon frame. If the STA misses a Beacon frame, or misses the latest Disabled Subchannel Bitmap subfield, the STA may be able to respond a trigger frame transmitted by an AP with an HE/EHT or other type of TB PPDU where the RU/MRU used for the STA to transmit UL data is assigned by the AP. The STA may not respond to a MU-RTS trigger frame with a CTS frame except when the CTS frame transmission is over the primary 20 MHz subchannel. This is because the AP does not include any punctured subchannel related information in the MU-RTS Trigger frame. Further, the STA may not initiate a transmission unless it is a 20 MHz bandwidth transmission.

In one method, a Disabled Subchannel Bitmap subfield/field may be included in the Multi-Link element or an element which may be carried on another link. For example, the Disabled Subchannel Bitmap subfield/field may be carried in the Per-STA Profile subelement in the Basic Multi-Link element. If an AP (e.g., the AP referred as the affected AP) affiliated with an AP MLD may have the Disabled Subchannel Bitmap subfield for itself carried in a Beacon frame or Probe Response frame it transmits, then another AP (e.g., a reporting AP) affiliated with the same AP MLD, and not corresponding to a non-transmitted BSSID, may carry the Disabled Subchannel Bitmap subfield/field in the STA Profile field of the Per-STA Profile subelement corresponding to the affected AP contained in the Basic Multi-Link element included in the Beacon frame and Probe Response frame that it transmits.

Embodiments for AP behavior with fully scheduled rTWT are described herein.

In one embodiment, a non-AP STA may be required not to request to establish membership in a restricted target wake time (rTWT) schedule advertised by the r-TWT scheduling AP with Restricted TWT Schedule Full subfield set to 1. In another word, a non-AP STA may not request to establish membership in a r-TWT schedule advertised by the r-TWT scheduling AP with Restricted TWT Schedule Full subfield set to 1.

A non-AP STA may request to become a member of a broadcast TWT or r-TWT by transmitting a frame to its associated AP that includes a TWT element with the Negotiation Type subfield set to 3 and the TWT Setup Command field set to Request TWT or Suggest TWT or Demand TWT, even though Restricted TWT Schedule Full subfield is set to 1 by the AP. The TWT parameter set may indicate the Broadcast TWT ID of the broadcast TWT that the STA is requesting to join.

In one embodiment, the TWT, or r-TWT, scheduling AP which receives a TWT element with the Negotiation Type subfield set to 3 and the TWT Setup Command field set to Request TWT or Suggest TWT or Demand TWT after the AP advertising that there is no schedule is available for accommodating any new membership, may respond with a unicast or individually addressed TWT element with the TWT Request field equal to 0 and the Negotiation Type subfield equal to 3.

The TWT Setup Command field indicating a Reject TWT. This means the TWT scheduled STA transmitting the initiating frame is a not a member of a broadcast TWT/r-TWT identified by the broadcast TWT ID and the transmitter address (TA) of the response frame. The TWT scheduling AP may not accept any new request from the TWT scheduled STA to join or create a broadcast TWT/r-TWT at this time.

The TWT Setup Command field indicating Alternate TWT and a Restricted TWT Parameter Set field is included. In this scenario, no new r-TWT schedule has been created with the TWT parameters indicated in the initiating frame. The r-TWT scheduling AP is offering an alternative set of parameters verses those indicated in the initiating frame, as a means of negotiating r-TWT parameters with the r-TWT scheduled STA. The TWT/r-TWT scheduled STA may send a new request with any set of TWT and r-TWT parameters, and the r-TWT scheduling AP may create a new r-TWT schedule using the parameters indicated in the responding frame.

The TWT Setup Command field indicating Alternate TWT and a no Restricted TWT Parameter Set field may be included. In this case, no new r-TWT schedule has been created with the TWT parameters indicated in the initiating frame. The TWT scheduling AP is offering an alternative set of parameters verses those indicated in the initiating frame, as a means of negotiating TWT parameters with the TWT scheduled STA. The TWT scheduled STA can send a new request with any set of TWT parameters and the TWT scheduling AP may create a new TWT schedule using the parameters indicated in the responding frame.

The TWT Setup Command field indicating Waiting List TWT and a Restricted TWT Parameter Set field may be included. In this case, no new r-TWT schedule has been created with the TWT parameters indicated in the initiating frame. The r-TWT scheduling AP may record the STA and its request in a waiting list. The TWT/r-TWT scheduled STA may receive a TWT Setup frame transmitted including a Restricted TWT Parameter Set field by the r-TWT scheduling AP later, to give the STA a membership of the TWT/r-TWT. In one method, a predefined or predetermined period may be used to determine the expected waiting time. For example, when the AP may accommodate the STA within the period, the AP may set the TWT Setup Command field to Waiting List TWT. Otherwise, the AP may set the TWT Setup Command field to Reject TWT or Alternate TWT. This predetermined/predefined period may be carried in a field, subfield, element, MAC header, management frame or control frame. In one method, the AP may broadcast the predetermined/predefined period to its STAs.

In one embodiment, the TWT, or r-TWT, scheduling AP, which receives the TWT element with the Negotiation Type subfield set to 3 and the TWT Setup Command field set to Request TWT or Suggest TWT or Demand TWT after the AP advertising that there is no schedule is available for accommodating any new membership, may not respond a unicast or individually addressed TWT Setup frame. If after a fixed period, the TWT/r-TWT scheduled STA may not receive any response frame from the TWT/r-TWT scheduling AP, the TWT/r-TWT scheduled STA may consider the initial request is on hold or rejected and the TWT/r-TWT membership is not granted.

Embodiments for enhanced multi-link multi-radio (EMLMR) operation are described herein. Embodiments for Enhanced multilink (EML) Control fields are described herein.

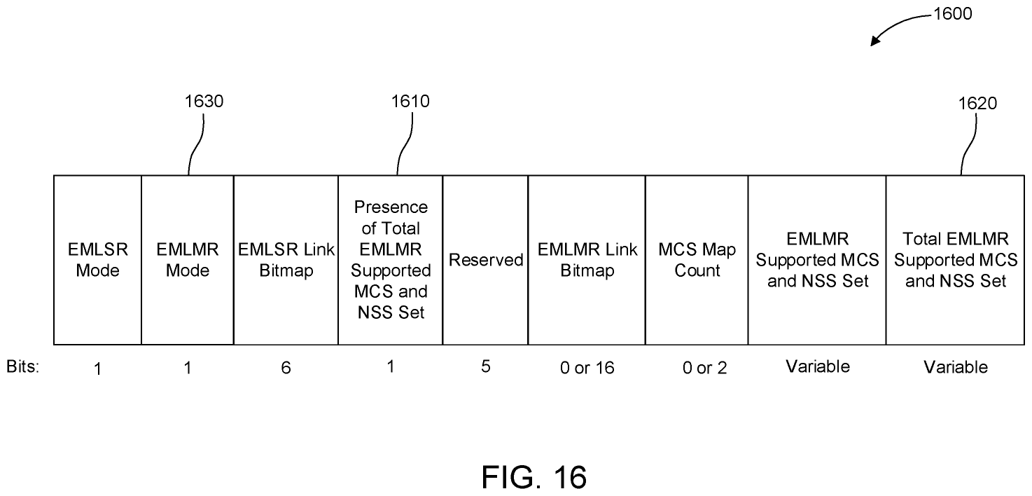

FIG. 16 is a diagram illustrating an example of a modified EML control field format-1 1600. In one embodiment, the capability on the total number of spatial streams that can be supported across multiple-enabled EMLMR links may be indicated by the non-AP MLD. The EML Control field 1600 may include two subfields: one is the Presence of Total EMLMR Supported MCS And NSS Set subfield 1610 and the other is the Total EMLMR Supported MCS And NSS Set subfield 1620, as depicted in FIG. 16. The Presence of Total EMLMR Supported MCS and NSS Set subfield 1610 may indicate if the Total EMLMR Supported MCS And NSS Set subfield 1620 is present or not. For example, when Presence subfield 1610 is set=0, it indicates the Total EMLMR Supported MCS And NSS Set subfield 1620 is not present or empty (i.e., this non-AP MLD may not have the limit on the total number of spatial streams when the set of EMLMR links are used for frame exchanges). When Presence subfield 1610 is set=1, it may indicate the Total EMLMR Supported MCS AND NSS Set field 1620 is present, i.e., this non-AP MLD has the limit on the total number of spatial streams when the set of EMLMR links are used for frame exchanges. The Total EMLMR Supported MCS And Nss Set subfield 1620 may indicate the combination of MCS and the number of spatial streams N_ss that a non-AP MLD supports on all EMLMR links simultaneously. The Presence of Total EMLMR Supported MCS And NSS subfield 1620 is set=0 when the EMLMR Mode subfield 1630 is set=0 (i.e., the Total EMLMR Supported MCS And NSS Set is not present when the EMLMR Mode subfield 1630 is set=0.)

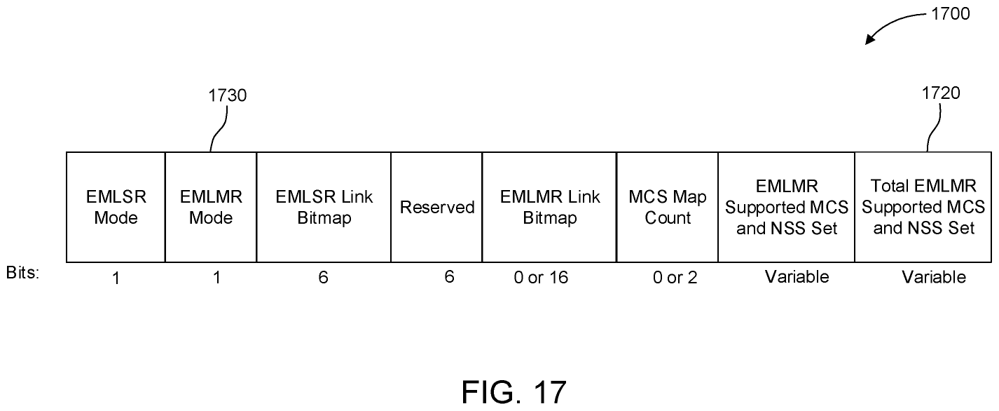

Alternatively, or additionally, only the Total EMLMR Supported MCS And NSS Set is added in the Enhanced EML Control field as shown in FIG. 17. FIG. 17 is a diagram illustrating an example enhanced EML control field format-2 1700. When the EMLMR Mode subfield 1730 is set=0, it means an EMLMR operation is not set, and the Total EMLMR Supported MCS And NSS Set subfield 1720 may not be not present. When the EMLMR Mode subfield 1730 is set=1, it means EMLMR operation is set, and the Total EMLMR Supported MCS And NSS Set subfield 1720 may be present.

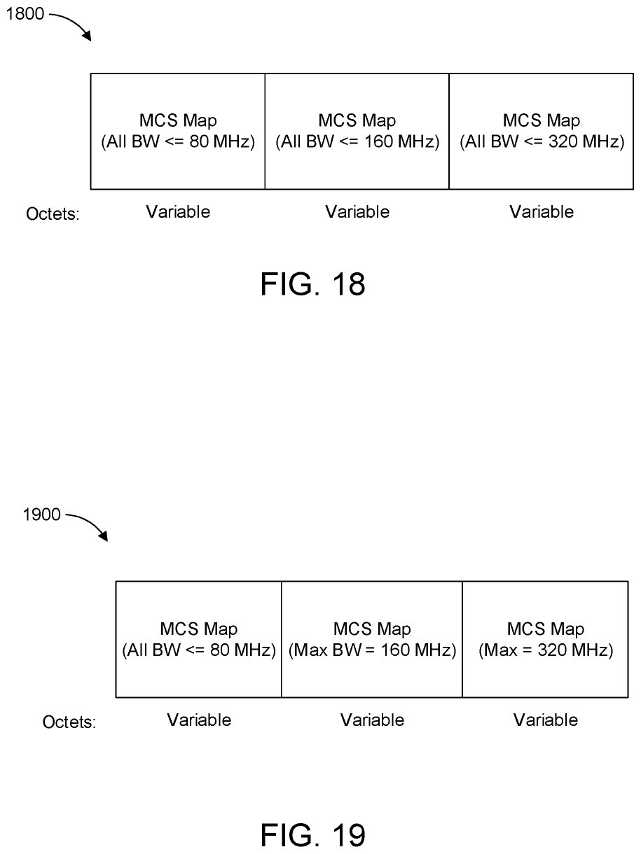

FIG. 18 is a diagram illustrating example subfields 1800 of a total EMLMR supported MCS and NSS set subfield format 1 (e.g., 1620; FIG. 16). FIG. 19 is a diagram illustrating example subfields 1900 of a total EMLMR Supported MCS And NSS Set subfield format 2 (e.g., 1720; FIG. 17).

The exemplary subfields 1800, 1900 of the total EMLMR Supported MCS And NSS Set subfield are defined in Table 4 below. It is noted that the combination of MCS for all links in Table 4 may be expressed as a vector or an array. The number of elements within the vector (or the array) may be equal to the number of links a non-AP MLD enables. Each element may represent the MCS value used in the corresponding link. For example, if there are three links for a non-AP MLD: Link 1 with Link ID=0 and Link 3 with Link ID=2 may be used for EMLMR operation (i.e., these two links correspond to the bit positions with value=1 in the EMLMR Link Bitmap subfield). The combination of MCS may be expressed as [MCS_LinkID0, Reserved, MCS_LinkID2], where MCS_LinkID0 represents the MCS used in Link 1, reserved means Link 2 with Link ID=1 is not in EMLMR mode and MCS_LinkID2 represents the MCS used in Link 3. Alternatively, or additionally, the number of elements within the vector (or the array) may be equal to the number of EMLMR links, which are the enabled links used by the non-AP MLD in the EMLMR mode. In other words, EMLMR links may be defined as the links which correspond to bit positions with the value 1 in the EMLMR Link Bitmap subfield. For example, if there are 3 links in a non-AP MLD and Link 1 with Link ID=0 and Link 3 with Link ID=2 are in EMLMR operation (i.e., these two links correspond to the bit positions with the value 1 in the EMLMR Link Bitmap subfield), then the combination of MCS may be expressed as [MCS_LinkID0, MCS_LinkID2], where MCS_LinkID0 represents the MCS used in Link 1 and MCS_LinkID2 represents the MCS used in Link 3.

TABLE 4

| Subfield | Definition |
|---|---|
| MCS Map (All | Except for a 20 MHz-only non-AP STA, it indicates the total maximum |
| BW <= 80 MHz) | number of spatial streams supported for receptions and the total |
| | maximum number of spatial streams for transmissions over all enabled |
| | EMLMR links for each combination of MCS when the maximum |
| | bandwidth over all enabled EMLMR links is 20, or 40 or 80 MHz. |
| MCS Map (All | If the maximum operating channel width of the non-AP MLD for the |
| BW <= 160 MHz MHz) | EMLMR operation is 160 MHz, it indicates the total maximum number |
| | of spatial streams supported for receptions and the total maximum |
| | number of spatial streams for transmissions over all enabled EMLMR |
| | links for each combination of MCS when the maximum bandwidth of the |
| | PPDU over all enabled EMLMR links is 160 MHz. |
| MCS Map (All | If the maximum operating channel width of the non-AP MLD for the |
| BW <= 160 MHz MHz) | EMLMR operation is 320 MHz, it indicates the total maximum number |
| | of spatial streams supported for receptions and the total maximum |
| | number of spatial streams for transmissions over all enabled EMLMR |
| | links for each combination of MCS when the maximum bandwidth of the |
| | PPDU over all enabled EMLMR links is 320 MHz. |

Embodiments for EMLMR mode enabling/disabling procedures are described herein.

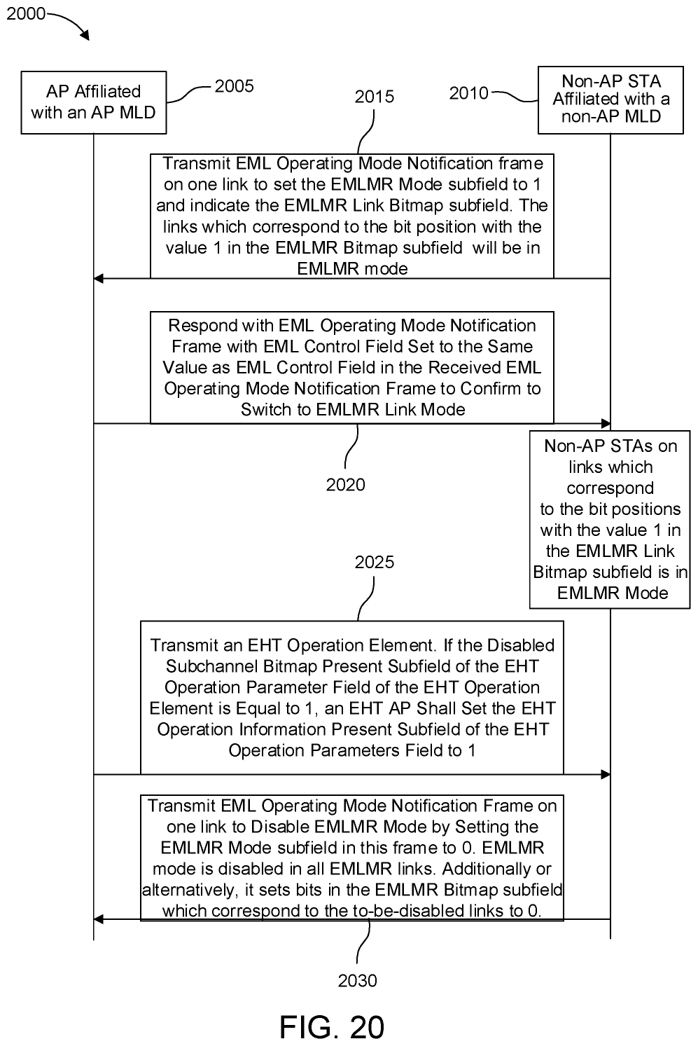

Referring to FIG. 20, a method 2000 for enabling/disabling EMLMR mode in communications between an AP 2005 affiliated with an AP MLD and a non-AP STA 2010 affiliated with a non-AP MLD is shown. In a first embodiment, if a non-AP MLD with dot11EHTEMLMROptionImplemented equal to true intends to switch to EMLMR mode after MLD association, then the non-AP STA 2010 affiliated with the non-AP MLD may transmit an EML Operating Mode Notification frame 2015 with EMLMR Mode subfield equal to 1 on one of the EMLMR links to enable EMLMR mode. Once the EML Operating Mode Notification frame 2015 is sent with EMLMR Mode subfield equal to 1, all links which correspond to the bit positions with the value 1 in the EMLMR Link Bitmap subfield may be in EMLMR mode. After the successful transmission of the EML Operating Mode Notification frame 2015 from the non-AP STA 2010 affiliated with the non-AP MLD to an AP 2005 affiliated with an AP MLD on any of EMLMR links, the non-AP STA 2010 and the AP 2005 may initialize the transition timeout timer with the Transition Timeout subfield value in the EML Capabilities subfield of the Basic Multi-Link element received from the AP. The transition timeout timer begins counting down from the end of the PPDU including the immediate response to the EML Operating Mode Notification frame. The AP 2005 may send an EML Operating Mode Notification frame response 2020 on the same link where the EML Operation Mode Notification frame 2015 is received to confirm the mode switch at the AP MLD side to the non-AP STA 2010 with EML Control field set to the same value as EML Control field in the received EML Operating Mode Notification frame 2015 from the non-AP STA 2010 before the transition timeout expires. This confirmation 2020 may indicate that the EMLMR mode is enabled on all links which correspond to the bit positions with the value=1 in the EMLMR Link Bitmap subfield.

After the EMLMR links are enabled, a frame 2025 may be transmitted by AP 2005 and received by station (STA) 2010 having an extremely high throughput (EHT) Operation element including a Disabled Subchannel Bitmap Present subfield and an EHT Operation Information Present subfield. When the Disabled Subchannel Bitmap Present subfield is equal to 1, the AP 2005 sets an EHT Operation Information Present subfield equal to 1.

In one example embodiment to disable active EMLMR links, the non-AP STA 2010 may then transmit its EML Operating Mode Notification frame 2030 on a link to disable EMLMR operation (e.g., disable all active EMLMR links) by setting the EMLMR Mode subfield in the EML Operating Mode Notification frame 2030 to 0. Additionally, or alternatively, it may set the bits in the EMLMR Bitmap subfield which correspond to the to-be-disabled links=0. In other words, the links which correspond to the bit positions with the value 0 in the EMLMR Link Bitmap subfield will not be in EMLMR mode.

In a second embodiment, if a non-AP MLD with dot11EHTEMLMROptionImplemented equal to true intends to switch to EMLMR mode after MLD association, then a non-AP STA affiliated with the non-AP MLD may transmit an EML Operating Mode Notification frame with EMLMR Mode subfield equal to 1 on one of the EMLMR links to enable EMLMR mode on the link where the EML Operating Mode Notification frame is transmitted. If the non-AP MLD wants to enable other EMLMR link which corresponds to the bit position with the value 1 in the EMLMR Link Bitmap subfield, the non-AP MLD may need to send another EML Operating Mode Notification frame with EMLMR Mode subfield equal to 1 on this link. After each successful transmission of the EML Operating Mode Notification frame 2015 from the non-AP STA 2010 affiliated with the non-AP MLD to an AP 2005 affiliated with an AP MLD, the non-AP STA and the AP may initialize the transition timeout timer with the Transition Timeout subfield value in the EML Capabilities subfield of the Basic Multi-Link element received from the AP. The transition timeout timer may begin counting down from the end of the PPDU including the immediate response to the EML Operating Mode Notification frame. The AP may send an EML Operating Mode Notification frame for confirming the mode switch at the AP MLD side to the non-AP STA with EML Control field set to the same value as EML Control field in the received EML Operating Mode Notification frame from the non-AP STA before the transition timeout expires. This confirmation indicates the EMLMR mode is enabled on the link where the EML Operating Mode Notification frame is transmitted. Similarly, when the EMLMR Mode subfield in the EML Operating Mode Notification frame is set to 0, EMLMR mode may only be disabled in the link where the EML Operating Mode Notification is received. Alternatively or additionally, when the EMLMR mode subfield in the EML Operating Mode Notification frame is set to 0 and sent in any EMLMR link, EMLMR mode may be disabled in all EMLMR links.

Embodiments for EHT-SIG Symbols Padding are described herein.

In one embodiment, the number of OFDM symbols in the EHT-SIG field, denoted as N_{sym,EHT-SIG}, may be computed by multiple methods that yield the same result. One example of the methods is given in Equation 2 below:

$$( Equation 2 )$$

$${N}_{sym , EHT - SIG} = \{ \begin{matrix}1 , & for EHT Sounding NDP \\ min ( 32 , ⌈ \frac{{N}_{bpcc}}{{N}_{DBPS}} ⌉ ) & otherwise\end{matrix}$$

where N_{DBPS} is the number of data bits per content channel per EHT-SIG OFDM and N_{bpcc} is the number of bits of the only content channel when the bandwidth of the PPDU is 20 MHz or the number of bits of the content channel which carries the largest number of User fields. N_{bpcc} may be computed using Equation 3 as follows:

$$( Equation 3 )$$

$${N}_{bpcc} = \{ \begin{matrix}52 + 22 ( {N}_{u} - 1 ) + 10 ⌈ \frac{( {N}_{u} - 1 )}{2} ⌉ , & for non - OFDMA transmission \\ \begin{matrix}27 + 9 N + 9 M + 10 ⌈ \frac{M}{M + 1} ⌉ + \\ 22 {N}_{u} + 10 ⌈ \frac{{N}_{u}}{2} ⌉\end{matrix} & for OFDMA transmission\end{matrix}$$

Where N is the number of RU Allocation-1 subfields, M is the number of RU Allocation-2 subfields and Nᵤ is the number of User fields including all dummy User fields used for padding purpose, and may be expressed as in Equation 4, Equation 5, Equation 6 and Equation 7 below: In one embodiment, Nᵤ can be expressed in the case that the bandwidth of the PPDU is 20 MHz as in Equation 4 below:

$$( Equation 4 )$$

$${N}_{u} = \{ \begin{matrix}{N}_{users} + {N}_{users , dummy} , & for non - OFDMA transmission \\ {max}_{c ∈ \{ 1 , 2 \}} {\sum }_{∀ r ∈ R} {N}_{user} ( r , c ) + {N}_{users , dummy} & for OFDMA transmission\end{matrix}$$

In one embodiment, Nᵤ can be expressed in the case that the bandwidth of the PPDU is 20 MHz and the padding type is bit-level padding or symbol-level padding as in Equation 5 below:

$${N}_{u} = \{ \begin{matrix}{N}_{users} , & for non - OFDMA transmission \\ {max}_{c ∈ \{ 1 , 2 \}} {\sum }_{∀ r ∈ R} {N}_{user} ( r , c ) & for OFDMA transmission\end{matrix} \qquad ( Equation 5 )$$

In one embodiment, Nᵤ can be expressed in the case that the bandwidth of the PPDU is greater than 20 MHz (or greater than or equal to 20 MHz) as in Equation 6 below:

$$( Equation 6 )$$

$${N}_{u} = \{ \begin{matrix}⌈ \frac{{N}_{users}}{2} ⌉ + {N}_{users , dummy} , & for non - OFDMA transmission \\ {max}_{c ∈ \{ 1 , 2 \}} {\sum }_{∀ r ∈ R} {N}_{user} ( r , c ) + {N}_{users , dummy} & for OFDMA transmission\end{matrix}$$

In one embodiment, Nᵤ can be expressed in the case that the bandwidth of the PPDU is greater than 20 MHz (or greater than or equal to 20 MHz) and the padding type is bit-level padding or symbol-level padding as in Equation 7 below:

$${N}_{u} = \{ \begin{matrix}⌈ \frac{{N}_{users}}{2} ⌉ , & for non - OFDMA transmission \\ {max}_{c ∈ \{ 1 , 2 \}} {\sum }_{∀ r ∈ R} {N}_{user} ( r , c ) & for OFDMA transmission\end{matrix} \qquad ( Equation 7 )$$

where Nᵤₛₑᵣₛ is signaled explicitly in the case of non-OFDMA transmission, N_{users,dummy} is the number of dummy users used for padding or any other purpose, R is the set of all RUs and MRUs which is signaled in RU Allocation-1 and RU Allocation-2 subfields and contributes nonzero users to the content channels and c is the index of the content channel.

In one embodiment, padding can be added to the EHT-SIG field for different purposes which may include the non-simultaneous transmit and receive (NSTR) PPDU alignment and A-PPDU alignment. Padding of the EHT-SIG field can take one of three different forms: bit-level padding, user-level padding and symbol-level padding. The bit-level padding may refer to the padding of the content channels of the EHT-SIG field with dummy bits which may take the value of 1 or 0 such that all dummy bits are either ones or zeros. The user-level padding may refer to the padding of the content channels of the EHT-SIG field with dummy User fields. The symbol-level padding may refer to padding the ET-SIG field by adding entire dummy OFDM symbols.

In one embodiment, the EHT-SIG field can be padded by adding extra dummy bits at the end of the content channel which include the largest number of User fields (i.e., the content channel with the largest number of data bits). The number of padding bits can be computed based on the required padding length in terms of OFDM symbols. The number of data bits per content channel after padding can be obtained by Equation 8 below:

$${N}_{bpcc , padding} = {N}_{bpcc} + {N}_{bit , padding} \qquad ( Equation 8 )$$

The length of padding OFDM symbols denoted as N_{sym,padding}, and the number of EHT-SIG symbols after padding denoted as N_{EHT-SIG Symbols,padding} which can be obtained by Equation 9 below:

$${N}_{EHT - SIG Symbols , padding} = {N}_{EHT - SIG Symbols} + {N}_{sym , padding} \qquad ( Equation 9 )$$

The number of padding bits N_{bit,padding} can then be computed as Equation 10 below:

$${N}_{bit , padding} = {N}_{sym , padding} \times {N}_{DBPS} \qquad ( Equation 10 )$$

The padding bits may be added to the end of the content channel and may take the value of 1 or 0 such that all dummy bits are either 1 or 0.

In one embodiment, Nᵤ in the case of bit-level padding or symbol-level padding may be expressed as Equation 11 below:

$${N}_{u} = \{ \begin{matrix}⌈ \frac{{N}_{users}}{2} ⌉ , & for non - OFDMA transmission \\ {max}_{c ∈ \{ 1 , 2 \}} {\sum }_{∀ r ∈ R} {N}_{user} ( r , c ) & for OFDMA transmission\end{matrix} \qquad ( Equation 11 )$$

where Nᵤ does not include any dummy user fields.

In one embodiment, the EHT-SIG field can be padded by adding extra dummy User fields to the content channel which includes the largest number of User fields. In one embodiment, the dummy User fields may include either all ones or all zeros such that the dummy User fields can be distinguished from the actual User fields comprising RU Allocation information. In another embodiment, the dummy User fields may be distinguished from the actual User fields by using a special STA ID which indicates that this User field is not corresponding to the actual user.

The number of dummy User fields, denoted as N_{users,dummy}, can be computed as Equation 12 below:

$${N}_{users , dummy} = ⌊ \frac{{N}_{sym , padding} {N}_{DBPS}}{{N}_{bpuf} + \frac{{N}_{crc + tail}}{2}} ⌋ \qquad ( Equation 12 )$$

In one embodiment, User-level padding by one dummy User field may result in padding of one or more OFDM symbols to the EHT-SIG field. In cases when Equation 12 above results in padding of zero dummy User fields, this may indicate that User-level padding may not be the suitable alternative of padding in these cases and bit-level padding and/or symbol-level padding may need to be used instead.

In one embodiment, the EHT-SIG field can be padded by adding extra OFDM symbols to the EHT-SIG field such that the number of EHT-SIG symbols after padding can be obtained by Equation 13 below:

$${N}_{EHT - SIG Symbols , padding} = {N}_{EHT - SIG Symbols} + {N}_{sym , padding} \qquad ( Equation 13 )$$

In one embodiment, the number of EHT SIG symbols after padding may not exceed the maximum number of allowed EHT-SIG symbols.

In one embodiment, the number of EHT-SIG symbols signaled to the receiver of the PPDU may include all or some EHT-SIG symbols in the preamble including the padding OFDM symbols whether the padded symbols are added according to bit-level padding, user-level padding, or symbol-level padding.

In one embodiment, the Number of Padding EHT-SIG OFDM symbols may be signaled in the U-SIG field or any other field in the transmitted PPDU which includes padding in the EHT-SIG field.

In one embodiment, the receiver of a PPDU with an EHT-SIG which includes padding either in bit-level, user-level, or symbol-level may decode the EGT-SIG field according to the following example procedures:

The receiver may decode the signaling field which indicates the number of EHT-SIG symbols (e.g., U-SIG field).

The receiver may extract the EHT-SIG field OFDM symbols based on the Number of EHT-SIG symbols.

The receiver may determine whether the PPDU is non-OFDMA transmission or OFDMA transmission. In case of non-OFDMA transmission, the number of actual User fields may be signaled explicitly such that the receiver can learn this parameter. In case of OFDMA transmission, the number of actual User fields can be determined by decoding the RU Allocation subfields which contributes nonzero User fields to the content channel.

In case of bit-level padding, the receiver can compute the number of bits of the content channel which carries actual allocation information and extract up to this number of bits from the decoded EHT-SIG based on the known number of User fields from the previous step(s).

In case of user-level padding, the receiver can extract the actual User fields which carries actual allocation information and extract up to this number of User fields from the decoded EHT SIG based on the known number of User fields from the previous step(s). In another example, the receiver can determine the padding User fields based on the special STA ID used to distinguish the padding User fields. In another example, the receiver can drop the padding User fields which carry all ones or all zeros bits.

In case of symbol-level padding, the receiver can compute the number of bits of the content channel which carries actual allocation information and then compute the required number of actual EHT SIG symbols. The receiver may then extract up to this number of OFDM symbols from the decoded EHT-SIG based on the known number of User fields from the previous step(s). In another example, the receiver can extract the actual EHT-SIG OFDM symbols from the received EHT-SIG field by learning the Number of Padding EHT-SIG OFDM symbols and subtract this number from the total Number of EHT-SIG symbols.

Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although four RBs per triggered TXOP are shown in some figures as example, the actual number of RBs/channels/bandwidth utilized may vary.

Although specific bits are used to signal in-BSS/OBSS as example, other bit may be used to signal this information.

Although some Trigger Type values are used as examples to identify the newly defined trigger frame variants, other values may be used.

Multi-AP and MAP are used interchangeably to refer to the same concept.

Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a station (STA), the method comprising:
receiving a frame from an access point (AP), the frame including an extremely high throughput (EHT) Operation element that includes a Disabled Channel Bitmap Present subfield and an EHT Operation Information Present subfield;
wherein on a condition the Disabled Channel Bitmap Present subfield is equal to 1 and the EHT Operation Information Present subfield is also equal to 1, receiving a Disabled Channel Bitmap field in an EHT Operation Information field to determine allowed subchannels for enhanced multi-link multi-radio (EMLMR) links.

2. The method of claim 1, further comprising:
transmitting a first enhanced multi-link (EML) operating mode notification frame to the AP, the first EML operating mode notification frame including an EMLMR Mode subfield with value of 1 and an EMLMR Bitmap subfield with one or more indications of EMLMR links the STA will use for EMLMR mode.

3. The method of claim 2, further comprising:
receiving an EML operating mode notification response frame from the AP, the EML operating mode notification response frame including an EML control field confirming EMLMR links indicated by the STA to use for EMLMR mode.

4. The method of claim 2, further comprising:
transmitting a second EML operating mode notification frame to the AP, the second EML operating mode notification frame including the EMLMR Mode subfield with the value of 0 and the EMLMR Bitmap subfield with one or more indications of EMLMR links the STA will disable EMLMR mode.

5. The method of claim 1, wherein the STA is a non-AP STA affiliated with a non-AP multilink device (MLD).

6. The method of claim 1, wherein the AP is an AP affiliated with an AP multilink device (MLD).

7. A station (STA) comprising:
a receiver configured to receive, from an access point (AP), a frame including an extremely high throughput (EHT) Operation element that includes a Disabled Channel Bitmap Present subfield and an EHT Operation Information Present subfield; and
a processor configured to determine, when the Disabled Channel Bitmap Present subfield is equal to 1 and the EHT Operation Information Present subfield is also equal to 1, allowed subchannels for enhanced multi-link multi-radio (EMLMR) links from a Disabled Channel Bitmap field indicated in an EHT Operation Information field.

8. The STA of claim 7, further comprising:
a transmitter configured to transmit a first enhanced multi-link (EML) operating mode notification frame to the AP, the first EML operating mode notification frame including an EMLMR Mode subfield with a value of 1 and an EMLMR Bitmap subfield with one or more indications of EMLMR links the STA will use for EMLMR mode.

9. The STA of claim 8, wherein the receiver is further configured to receive an EML operating mode notification response frame from the AP, the EML operating mode notification response frame including an EML control field confirming EMLMR links indicated by the STA to use for EMLMR mode.

10. The STA of claim 8, wherein the transmitter is further configured to transmit a second EML operating mode notification frame to the AP, the second EML operating mode notification frame including the EMLMR Mode subfield with a value of 0 and the EMLMR Bitmap subfield with one or more indications of EMLMR links the STA will disable from EMLMR mode.

11. The STA of claim 7, wherein the STA is a non-AP STA affiliated with a non-AP multilink device (MLD).

12. The STA of claim 7, wherein the AP is an AP affiliated with an AP multilink device (MLD).

13. An access point (AP) comprising:
a transceiver and a processor in communication with the transceiver, the transceiver and processor configured to:
transmit a frame to a station (STA), the frame including an extremely high throughput (EHT) Operation element that includes a Disabled Channel Bitmap Present subfield=1, an EHT Operation Information Present subfield=1 and a Disabled Channel Bitmap field indicated in an EHT Operation Information field to indicate to the STA, allowed subchannels for enhanced multi-link multi-radio (EMLMR) links.

14. The AP of claim 13, wherein the transceiver and processor are further configured to:
receive a first enhanced multi-link (EML) operating mode notification frame from the STA, the first EML operating mode notification frame including an EMLMR Mode subfield with a value of 1 and an EMLMR Bitmap subfield with one or more indications of EMLMR links the STA will use for EMLMR mode.

15. The AP of claim 14, wherein the transceiver and processor are further configured to:
transmit an EML operating mode notification response frame to the STA, the EML operating mode notification response frame including an EML control field confirming EMLMR links indicated by the STA to use for EMLMR mode.

16. The AP of claim 14, wherein the transceiver and processor are further configured to:
receive a second EML operating mode notification frame from the STA, the second EML operating mode notification frame including the EMLMR Mode subfield with a value of 0 and the EMLMR Bitmap subfield with one or more indications of EMLMR links the STA will disable EMLMR mode.

17. The AP of claim 13, wherein the STA is a non-AP STA affiliated with a non-AP multilink device (MLD).

18. The AP of claim 13, wherein the AP is an AP affiliated with an AP multilink device (MLD).
